(19) United States
(12) Patent Application Publication
(10) Pub. No.: US 2012/0220252 A1
(43) Pub. Date: Aug. 30, 2012

(54) PORTABLE ELECTRONIC DEVICE AND CONTROL METHOD THEREOF

(76) Inventors: Chung-Yu TSENG, Taipei (TW); Po-Wen HUANG, Taipei (TW); Kuei-Fung TU, Taipei (TW)

(21) Appl. No.: 13/401,285

(22) Filed: Feb. 21, 2012

Related U.S. Application Data
(60) Provisional application No. 61/446,265, filed on Feb. 24, 2011.

(51) Int. Cl. H04B 1/06

(52) U.S. Cl. 455/272

(57) ABSTRACT

A portable electronic device connected to a peripheral electronic device is disclosed. The peripheral electronic device includes an external output module and a second antenna module. The portable electronic device includes a first antenna module, a receiving processing module and a built-in output module. The first antenna module receives an input signal. The receiving processing module is electrically connected to the first antenna module to process the input signal to generate an output signal. The built-in output module is electrically connected to the receiving processing module to output the output signal. When the receiving processing module is connected to the peripheral electronic device, the second antenna module receives the input signal, the receiving processing module processes the input signal to generate the output signal, and the external output module outputs the output signal. A control method of the portable electronic device is also disclosed.

### CROSS REFERENCE TO RELATED APPLICATIONS

The non-provisional patent application claims priority to U.S. provisional patent application with Ser. No. 61/446,265 filed on Feb. 24, 2011. This and all other extrinsic materials discussed herein are incorporated by reference in their entirety.

### BACKGROUND OF THE INVENTION

1. Field of Invention

The invention relates to an electronic device and a control method thereof and, more particularly, to a portable electronic device and a control method thereof.

2. Related Art

More and more users in modem society use a portable electronic device such as a radio or a Walkman to listen to broadcast. As the electrical technology develops, the portable electronic device is not only for broadcast receiving, but also the digital television (TV).

Moreover, the dimension of the portable electronic device becomes smaller for conveniently carried. However, an antenna is usually disposed in the body of the device. Consequently, when the portable electronic device is covered by outer cases, the signal may be shielded or the signal quality is bad, which is rather inconvenient for the user.

### SUMMARY OF THE INVENTION

A portable electronic device connected to a peripheral electronic device is disclosed. The peripheral electronic device includes an external output module and a second antenna module. The portable electronic device includes a first antenna module, a receiving processing module and a built-in output module.

The first antenna module receives an input signal. The receiving processing module is electrically connected to the first antenna module to process the input signal to generate an output signal. The built-in output module is electrically connected to the receiving processing module to output the output signal. When the receiving processing module is connected to the peripheral electronic device, the second antenna module receives the input signal, the receiving processing module processes the input signal to generate the output signal, and the external output module outputs the output signal.

A control method of a portable electronic device is also disclosed herein. The method includes the steps of: receiving an input signal by a first antenna module; outputting an output signal by a built-in output module via a receiving processing module according to the input signal; receiving the input signal via a second antenna module of the peripheral electronic device when a peripheral electronic device is connected to the portable electronic device; and outputting at least a part of the output signal by an external output module of the peripheral electronic device via the receiving processing module according to the input signal.

These and other features, aspects and advantages of the present invention will become better understood with regard to the following description, appended claims, and accompanying drawings.

### BRIEF DESCRIPTION OF THE DRAWINGS

FIG. 1A is a schematic diagram showing a portable electronic device in an operation state in an embodiment;

FIG. 1B is a schematic diagram showing a portable electronic device in another operation state in an embodiment;

FIG. 2 is a schematic diagram showing a variation of a portable electronic device in operation in an embodiment; and

FIG. 3A and FIG. 3B are flow charts showing a control method of a portable electronic device in an embodiment.

### DETAILED DESCRIPTION OF THE INVENTION

A portable electronic device and a control method are illustrated with relating figures, and the symbols denote the same components.

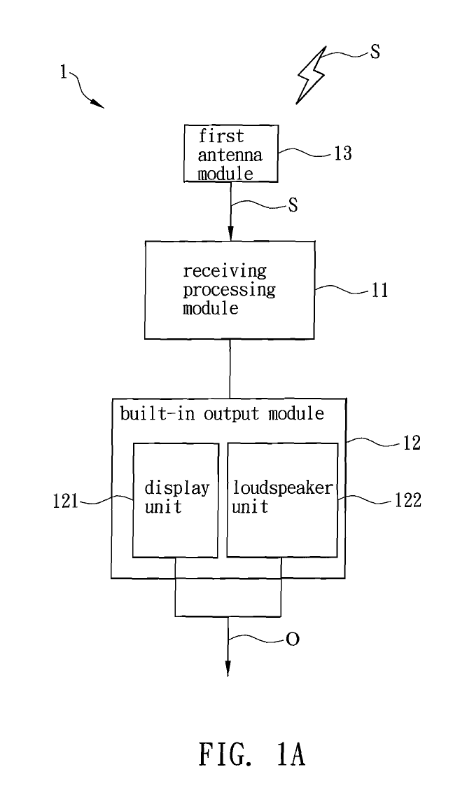

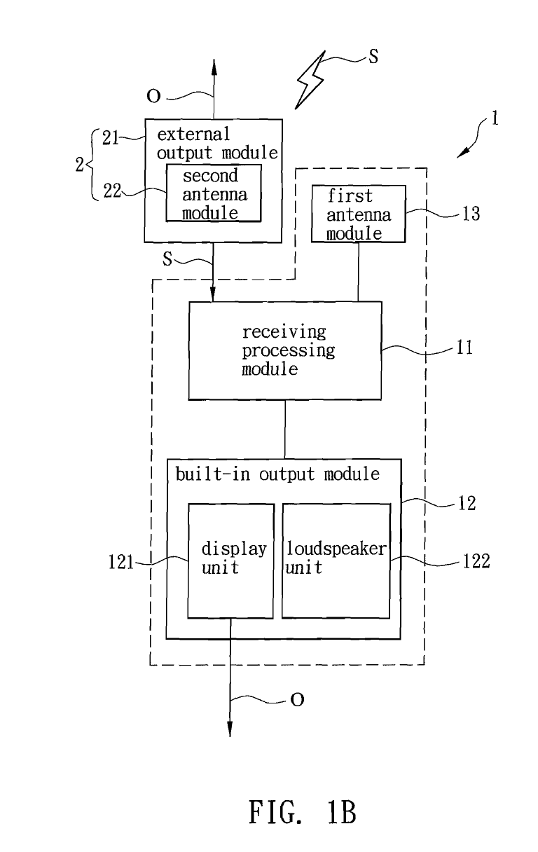

FIG. 1A is a schematic diagram showing a portable electronic device 1 in an operation state in an embodiment. The portable electronic device 1 may be a mobile communication device, a personal digital assistant (PDA) or a video player, and it can receive an input signal S. The input signal S may be a digital video signal, a frequency modulation (FM) radio signal or other video or broadcast signals. The portable electronic device 1 includes a receiving processing module 11, a built-in output module 12 and a first antenna module 13.

The receiving processing module 11 may include a baseband processor, a FM signal receiver and a digital TV receiver, which is not limited and can be adjusted according to requirements.

The built-in output module 12 is electrically connected to the receiving processing module 11. The built-in output module 12 may include a display unit 121 and a loudspeaker unit 122. The display unit 121 may be a display panel or a touch control panel.

The first antenna module 13 is electrically connected to the receiving processing module 11. When the first antenna module 13 receives the input signal S, the receiving processing module 11 outputs an output signal O via the built-in output module 12 according to the input signal S. If the input signal S is a digital video signal, the user can watch video via the display unit 121 and listen to sound via the loudspeaker unit 122. If the input signal S is a FM radio signal, the user can listen to the sound via the loudspeaker unit 122.

FIG. 1B is a schematic diagram showing a portable electronic device 1 in another operation state in an embodiment. The portable electronic device 1 can be connected to a peripheral electronic device 2. The peripheral electronic device 2 includes an external output module 21 and a second antenna module 22, and the external output module 21 of the peripheral electronic device 2 may be an earphone module or a loudspeaker module.

The receiving processing module 11 is electrically connected to the peripheral electronic device 2, and the input signal S is received by the second antenna module 22 of the peripheral electronic device 2. The receiving processing module 11 outputs at least a part of the output signal O via the external output module 21 according to the input signal. If the input signal S is a digital video signal, the user can watch video via the display unit 121 and listen to sound via the external output module 21 (such as an earphone module or a loudspeaker module). For example, the input signal S is a FM radio signal, and the user can listen to the sound via the external output module 21.

Thus, when the user puts the portable electronic device 1 in a shielded position such as a pocket, the signal of the built-in first antenna module 13 may be shielded. However, the portable electronic device 1 can be electrically connected to the peripheral electronic device 2, for the portable electronic device 1 receives the input signal S via the second antenna module 22 of the peripheral electronic device 2 to avoid signal shielded and improve the communication quality of the portable electronic device 1.

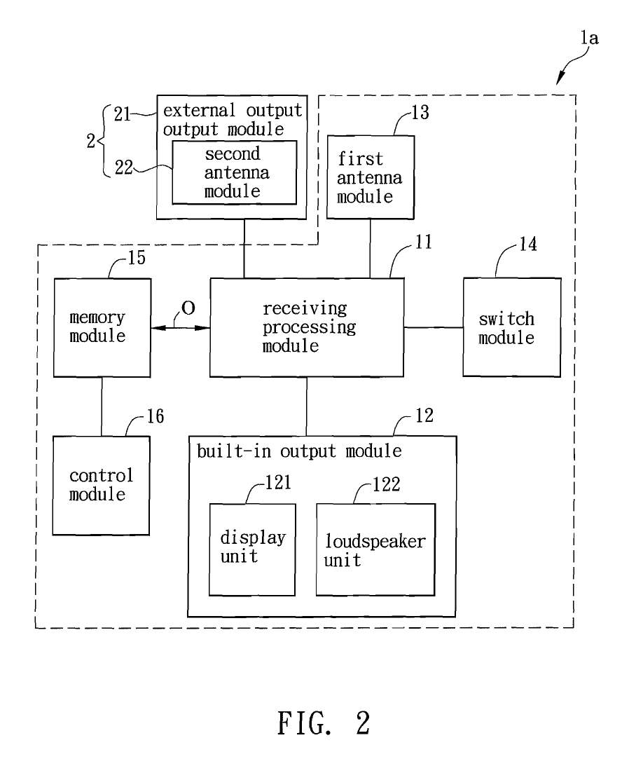

FIG. 2 is a schematic diagram showing a variation of a portable electronic device 1a in operation in an embodiment. The portable electronic device 1a further includes a switch module 14, a memory module 15 and a control module 16. The switch module 14 is electrically connected to the receiving processing module 11 to switch between the first antenna module 13 and the second antenna module 22 to receive the digital video signal or the FM radio signal by demand. The memory module 15 is electrically connected to the receiving processing module 11 and stores the output signal O. The control module 16 is electrically connected to the memory module 15 to control the memory module 15 to store or output the output signal O. Thus, the user can store the output signal O and watch or listen to programs anytime via the control module 16, which provides convenience.

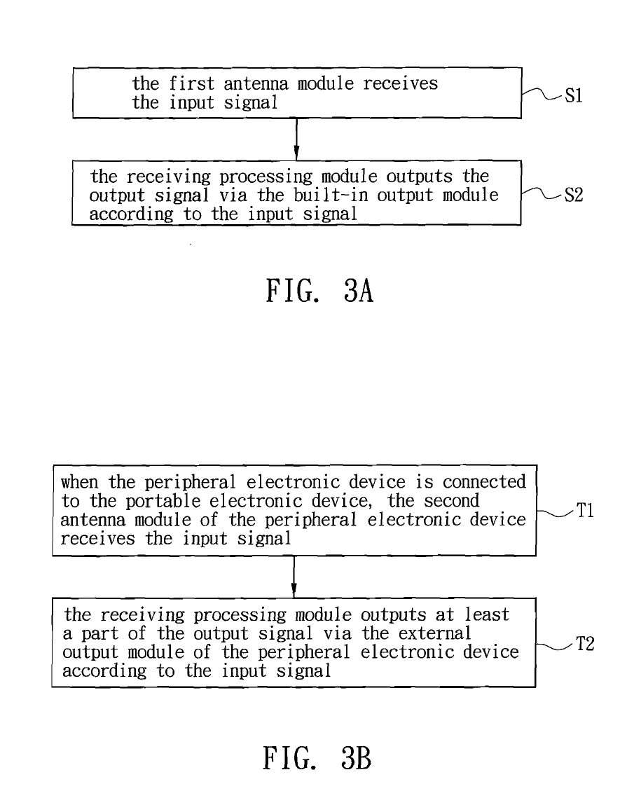

FIG. 3A and FIG. 3B are flow charts showing a control method of a portable electronic device in an embodiment. In FIG. 3A, the control method of the portable electronic device includes step S1 and step S2. In step S1, the first antenna module receives the input signal. In step S2, the receiving processing module outputs the output signal via the built-in output module according to the input signal. In FIG. 3B, the control method of the portable electronic device includes step T1 and step T2. In step T1, when the peripheral electronic device is connected to the portable electronic device, the second antenna module of the peripheral electronic device receives the input signal. In step T2, the receiving processing module outputs at least a part of the output signal via the external output module of the peripheral electronic device according to the input signal. The variation of the control method of the portable electronic device is illustrated above, which is omitted herein.

In sum, according to the portable electronic device and the control method thereof, when the receiving processing module of the portable electronic device is electrically connected to the external output module (such as an earphone module) of the peripheral electronic device, the portable electronic device receives the input signal via the second antenna module of the peripheral electronic device. Consequently, when the portable electronic device is put in a pocket, the possible signal shield can be avoided and the signal receiving quality of the portable electronic device is improved.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A portable electronic device connected to a peripheral electronic device, wherein the peripheral electronic device includes an external output module and a second antenna module, the portable electronic device comprising:
a first antenna module receiving an input signal;
a receiving processing module electrically connected to the first antenna module to process the input signal to generate an output signal; and
a built-in output module electrically connected to the receiving processing module to output the output signal, wherein when the receiving processing module is connected to the peripheral electronic device, the second antenna module receives the input signal, the receiving processing module processes the input signal to generate the output signal, and the external output module outputs the output signal.

2. The portable electronic device according to claim 1, wherein the portable electronic device further includes:
a memory module electrically connected to the receiving processing module to store the output signal; and
a control module electrically connected to the memory module to control the memory module to store or output the output signal.

3. The portable electronic device according to claim 1, wherein the external output module is an earphone module or a loudspeaker module.

4. The portable electronic device according to claim 1, wherein the built-in output module includes a display unit and a loudspeaker unit.

5. The portable electronic device according to claim 1, wherein the input signal is a digital video signal or a frequency modulation (FM) radio signal.

6. The portable electronic device according to claim 5, wherein the portable electronic device further includes:
a switch module electrically connected to the receiving processing module to switch between the first antenna module and the second antenna module to receive the digital video signal or the FM radio signal.

7. A control method of a portable electronic device, comprising:
receiving an input signal by a first antenna module;
outputting an output signal by a built-in output module via a receiving processing module according to the input signal;
receiving the input signal via a second antenna module of the peripheral electronic device when a peripheral electronic device is connected to the portable electronic device; and
outputting at least a part of the output signal by an external output module of the peripheral electronic device via the receiving processing module according to the input signal.

8. The control method according to claim 7, the control method further includes:
storing the output signal via a memory module; and
controlling the memory module to output the output signal via a control module.

9. The control method according to claim 7, wherein the input signal is a digital video signal or a frequency modulation (FM) radio signal.

10. The control method according to claim 9, wherein the control method further includes:
switching between the first antenna module and the second antenna module to receive the digital video signal or the FM radio signal by a switch module.
